(19) United States
(12) Patent Application Publication
(10) Pub. No.: US 2025/0392217 A1
(43) Pub. Date: Dec. 25, 2025

(54) POWER CONVERTER STAGE

(71) Applicant: Qorvo US, Inc., Greensboro, NC (US)

(72) Inventor: Douglas R. Farrenkopf, Carlsbad, CA (US)

(21) Appl. No.: 19/241,542

(22) Filed: Jun. 18, 2025

Related U.S. Application Data
(60) Provisional application No. 63/663,875, filed on Jun. 25, 2024.

(51) Int. Cl. H02M 3/157; H02M 3/158; H04B 1/40

(52) U.S. Cl. CPC H02M 3/157; H02M 3/1582; H04B 1/40

(57) ABSTRACT

The present disclosure relates to a power converter stage that includes a high-side n-type metal oxide semiconductor (NMOS) transistor, which functions as both a high-side switch in buck mode and a low-side switch in boost mode. The power converter also incorporates a charge pump circuit that generates a higher output voltage when operating in boost mode. A bootstrapped driver selectively activates the high-side transistor to function as either a high-side switch or a low-side switch based on the desired output voltage level. In buck mode (when the desired output voltage is lower than the supply voltage), the high-side transistor functions as a high-side switch, while in boost mode (when the desired output voltage surpasses the input voltage), the high-side transistor operates as a low-side switch to alternately switch the switched node between the supply voltage and twice its value via the charge pump circuit.

### RELATED APPLICATIONS

This application claims the benefit of provisional patent application Ser. No. 63/663,875, filed Jun. 25, 2024, the disclosure of which is hereby incorporated herein by reference in its entirety.

### FIELD OF THE DISCLOSURE

This disclosure generally relates to power conversion stages in electronic devices, and more specifically, to high-efficiency n-type metal oxide semiconductors used as either a high-side switch or a low-side switch for buck/boost power converters with integrated charge pump circuitry.

### BACKGROUND

A primary purpose of any direct current-direct current (DCDC) converter is to convert an input voltage to an output voltage of different value with minimal power loss (Pin-Pout) or maximum efficiency (Pout/Pin). A primary source of power loss in a DCDC converter is the resistance of the switches used in its power conversion stage. Every DCDC converter has its own limitations regarding how low the power loss can be and how high its efficiency can be. As such, improving these metrics is desirable as they significantly impact battery life and internal heating within the application where the converter is used.

### SUMMARY

Disclosed is an architecture for a power converter stage with an added n-type metal oxide semiconductor (NMOS) power switch with its associated smaller support NMOS/p-type metal oxide semiconductor (PMOS) transistors and control circuitry.

In this modification, an NMOS switch is added between Vbat and LX. For Vout less than Vbat, this NMOS is used as a high-side switch and LX is bucked between Vbat and ground (buck mode). The Ron of this NMOS switch is much lower than that of the stacked PMOS high-side switch in traditional power converter circuitry and results in higher efficiency.

For Vout greater than Vbat, LX is bucked between 2Vbat and Vbat (boost mode). The added NMOS switch then serves as a low-side switch. For a given Vout in boost mode, the duty cycle is less than that of traditional power converter circuitry, which bucks between two times a battery voltage Vbat and ground. Having a lower duty cycle allows the low Ron NMOS to be on for a larger fraction of the duty cycle, which increases the efficiency of the power converter stage.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1 is a schematic of a power converter stage that is structured in accordance with the present disclosure.

FIG. 2 is the schematic of the power converter stage with states of transistors that have continuous states during a buck mode.

FIG. 3 is a simplified schematic of the power converter stage that illustrates the active circuitry during the buck mode.

FIG. 4 is the schematic of the power converter stage with states of transistors that have continuous states during a boost mode.

FIG. 5 is a simplified schematic of the power converter stage that illustrates the active circuitry during the boost mode.

FIG. 6 is a graph of efficiency of the power converter stage versus load current in comparison with traditional power converter circuitry of similar input voltage of 3.8 V and output voltage of 2.8 V.

FIG. 7 is a graph of power dissipation of the power converter stage versus load current in comparison with traditional power converter circuitry of similar input voltage of 3.8 V and output voltage of 2.8 V.

FIG. 8 is a graph of power dissipation of the power converter stage versus load current in comparison with traditional power converter circuitry of similar input voltage of 3.8 V and output voltage of 5.5 V.

FIG. 9 is a diagram showing how the disclosed power converter stage may be employed in communication devices such as wireless communication devices.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

The disclosed architecture is made up of a power converter stage featuring an added n-type metal oxide semiconductor (NMOS) power switch, accompanied by smaller support NMOS and p-type metal oxide semiconductor (PMOS) transistors, as well as control circuitry. In this modification, an NMOS switch is inserted between a battery voltage Vbat and a switched node LX. When the voltage output (Vout) is less than that of Vbat, this NMOS acts as a high-side switch, and LX is bucked between Vbat and ground in what is known as buck mode. The on-resistance (Ron) of this NMOS switch is significantly lower than that of the stacked PMOS high-side switch found in traditional power converter circuitry, thereby improving efficiency. When Vout exceeds Vbat, LX is then switched between twice Vbat and Vbat, operating in boost mode. In this scenario, the added NMOS switch functions as a low-side switch. For a given Vout in boost mode, the duty cycle is less than that of traditional power converter circuitry, which switches between twice the battery voltage (Vbat) and ground. A lower duty cycle enables the low Ron NMOS to remain active for a larger fraction of the duty cycle, thereby enhancing the efficiency of the power converter stage. It is to be understood that in some embodiments, NMOS transistors are n-type double-diffused metal oxide semiconductor (nDMOS) transistors and that PMOS transistors are the p-type double-diffused metal oxide semiconductor (pDMOS) transistors.

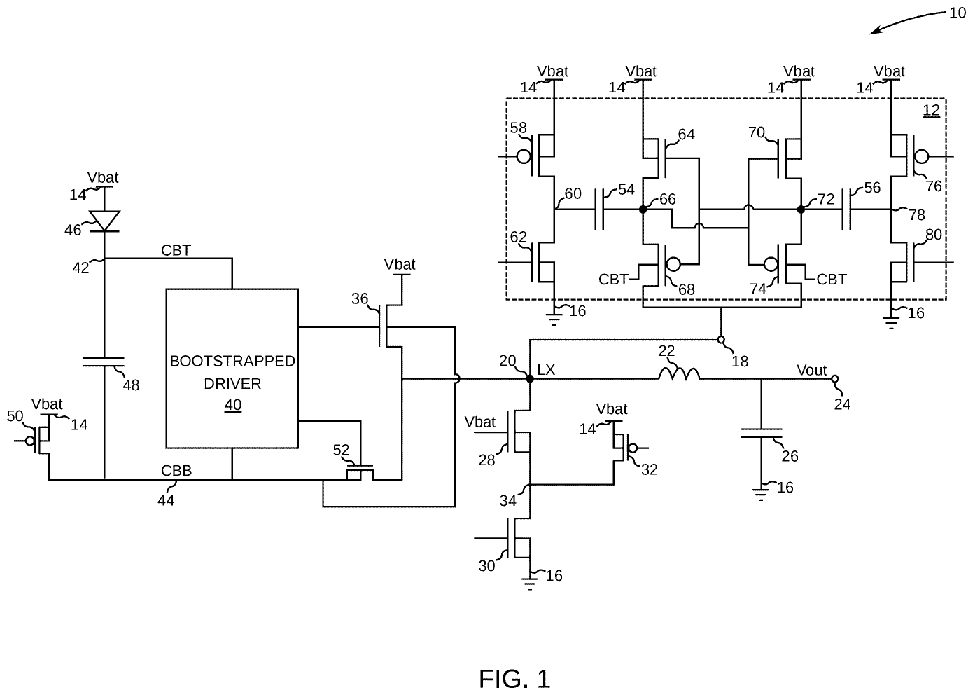

FIG. 1 is a schematic of a power converter stage 10 that is structured in accordance with the present disclosure. The power converter stage 10 has charge pump circuitry 12 that is coupled between a supply voltage node 14 and a fixed voltage node 16 that is typically at ground potential. The supply voltage node 14 is configured to typically receive a battery voltage, which is labeled Vbat in this disclosure. The charge pump circuitry 12 has a pumped output 18 that is coupled to a switched node 20 that is labeled LX. An output inductor 22 is coupled between the switched node 20 and a power output terminal 24. In some embodiments the inductance of the output inductor 22 is between 0.1 μH and 0.5 μH. In some other embodiments the inductance of the output inductor 22 is between 0.5 μH and 2 μH. In some embodiments the inductance of the output inductor 22 is typically 1 μH. An output filter capacitor 26 is coupled between the power output terminal 24 and the fixed voltage node 16. Capacitance of the output filter capacitor 26 is typically 4.4 μF. In other embodiments, a range of capacitance for the output filter capacitor 26 is between 0.2 μF and 10 μF. The provided capacitance and inductance ranges, as disclosed, serve merely as examples and can extend beyond these limits without straying from the scope of this disclosure. For instance, in applications requiring a more rapid change in output voltage (Vout), an inductance value of 240 nH may be selected for the output inductor 22, and a capacitance value of 470 nF may be chosen for the output filter capacitor 26.

A first ground-side transistor 28 and a second ground-side transistor 30 are coupled in series between the switched node 20 and the fixed voltage node 16. A third ground-side transistor 32 is coupled between the supply voltage node 14 and a ground-side node 34. In the exemplary embodiment of FIG. 1, the first ground-side transistor 28 and the second ground-side transistor 30 are each an n-type metal oxide semiconductor (NMOS) transistor. A third ground-side transistor 32 is a p-type metal oxide semiconductor (PMOS) transistor.

A high-side transistor 36 is coupled between the supply voltage node 14 and the switched node 20. A bootstrapped driver 40 is configured to provide drive voltage signals to the high-side transistor 36. The bootstrapped driver 40 is coupled between a first bootstrap node 42 labeled CBT and a second bootstrap node 44 labeled CBB. A bootstrap diode 46 has an anode coupled to the supply voltage node 14 and a cathode coupled to the first bootstrap node 42. A bootstrap capacitor 48 is coupled between the first bootstrap node 42 and the second bootstrap node 44. The capacitance of the bootstrap 48 may be within a range from 0.2 μF to 10 μF. In an exemplary embodiment, capacitance of the bootstrap capacitor 48 is 100 nF±10%. A first bootstrap transistor 50 is coupled between the supply voltage node 14 and the second bootstrap node 44. In the exemplary embodiment of FIG. 1, the first bootstrap transistor 50 is a PMOS transistor.

A second bootstrap transistor 52 has a drain coupled to a source of the high-side transistor 36 and a source coupled to the second bootstrap node 44. The source of the second bootstrap transistor 52 is also coupled to the bulk (i.e., body) of the high-side transistor 36. A gate of the second bootstrap transistor 52 is configured to be driven by the bootstrapped driver 40.

Returning to the charge pump circuitry 12 in greater detail, the exemplary embodiment is configured to alternately charge and discharge a first flying capacitor 54 and a second flying capacitor 56. Charging and discharging of the first flying capacitor 54 is controlled by a first pump transistor 58 coupled between the supply voltage node 14 and a first plate node 60, a second pump transistor 62 coupled between the fixed voltage node 16 and the first plate node 60, a third pump transistor 64 coupled between the supply voltage node 14 and a second plate node 66, and a fourth pump transistor 68 coupled between the pumped output 18 and the second plate node 66.

Similarly, charging and discharging of the second flying capacitor 56 is controlled by a fifth pump transistor 70 coupled between the supply voltage node 14 and a third plate node 72, a sixth pump transistor 74 coupled between the pumped output 18 and the third plate node 72, a seventh pump transistor 76 coupled between the supply voltage node 14 and a fourth plate node 78, and a eighth pump transistor 80 coupled between the pumped output 18 and the fourth plate node 78. In the embodiments shown in FIGS. 1-5, the bootstrapped driver 40 drives the gates of the high-side transistor 36, the first bootstrap transistor 50, and the second bootstrap transistor 52. Other transistors including the transistors of the charge pump circuitry 12 are driven by regular logic buffers (not shown).

The efficiency in boost mode may be improved by making the PMOS transistors a little larger and the n-type double-diffused metal oxide semiconductor (nDMOS) transistors a little smaller. Also, the first pump transistor 58 and the seventh pump transistor 76 may be converted from pDMOS to NMOS transistors, which would also increase the efficiency of the power converter stage 10. Note that if the first pump transistor 58 and the seventh pump transistor 76 are changed to NMOS devices, they will be driven by bootstrapped drivers.

The high-side transistor 36 is an NMOS transistor because it is desirable for the high-side transistor 36 to have a relatively lower on resistance (Ron) than the Ron of PMOS transistors such as the fourth pump transistor 68 or the sixth pump transistor 74. The third ground-side transistor 32 is used to hold the source of the first ground-side transistor 28 when the first ground-side transistor 28 is off. For an output voltage Vout less than the battery voltage Vbat, the high-side transistor 36 is configured as a switch and voltage at the switched node 20 (i.e., LX) is bucked between the battery voltage Vbat and ground when the power converter stage is operating in a buck mode. Since the Ron of the high-side transistor 36 is substantially much lower than that of a typical stacked PMOS high-side switch, a much higher energy efficiency is realized by the power converter stage 10.

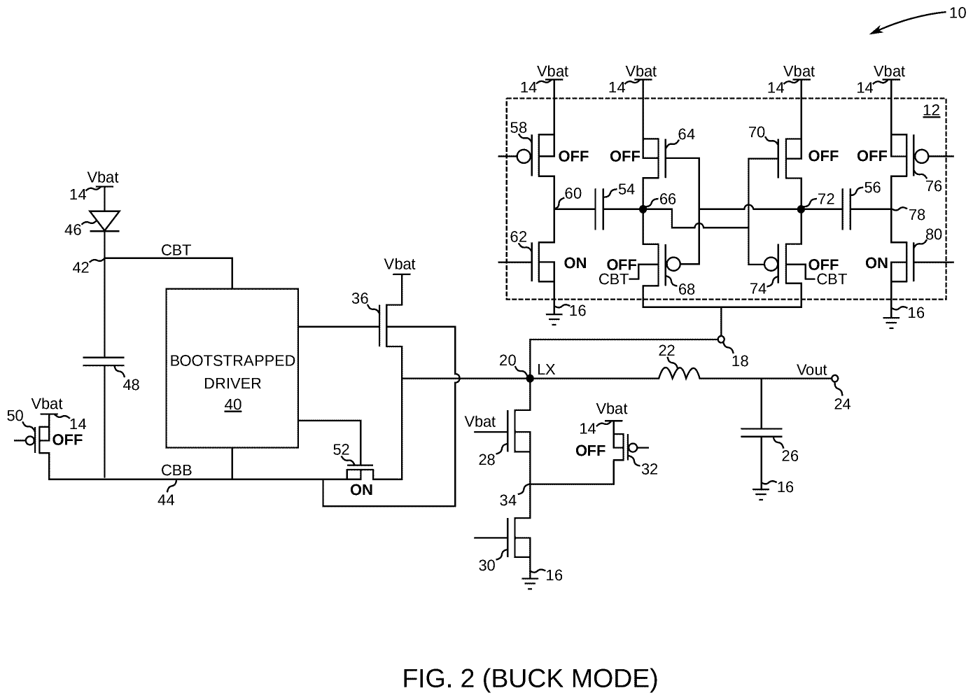

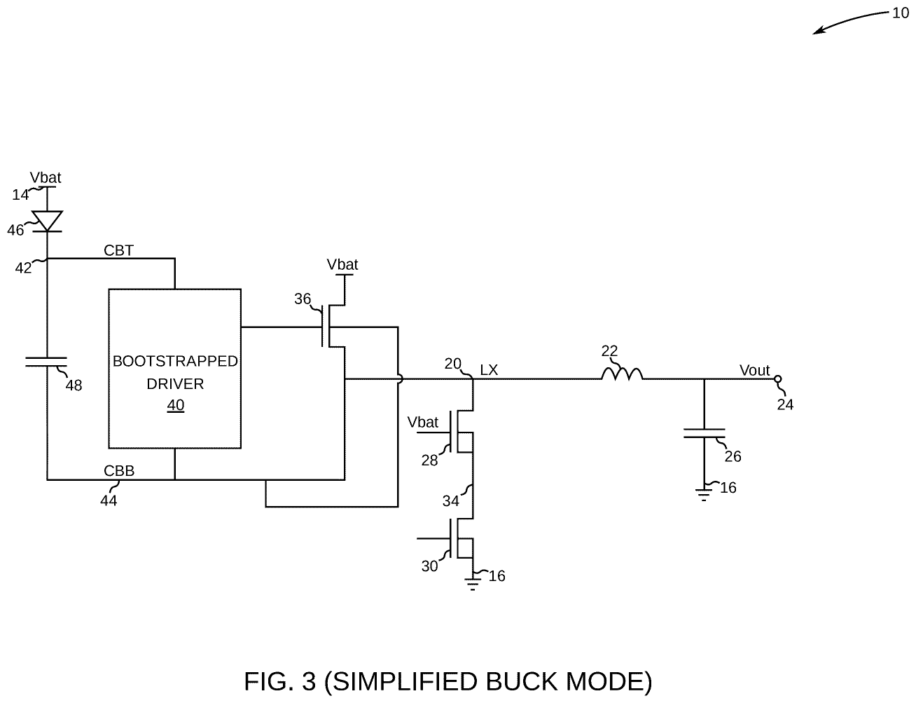

FIG. 2 is the schematic of the power converter stage 10 with static conduction states of transistors that are either on or off during a buck mode. The conduction states are labeled in bold text placed next to the symbols of the transistors that are either on or off during the buck mode. FIG. 3 is a simplified version of the schematic of FIG. 2 when the power converter stage 10 is operated in the buck mode. In the simplified schematic of FIG. 3, the charge pump circuitry 12 is not shown because the charge pump circuitry 12 is not employed in the buck mode. The third ground-side transistor 32 is not shown because it is turned off during buck mode operation. The first bootstrap transistor 50 is not shown because it is turned off during the buck mode. The second bootstrap transistor 52 is depicted as a short because the second bootstrap transistor 52 is continuously on during buck mode operation.

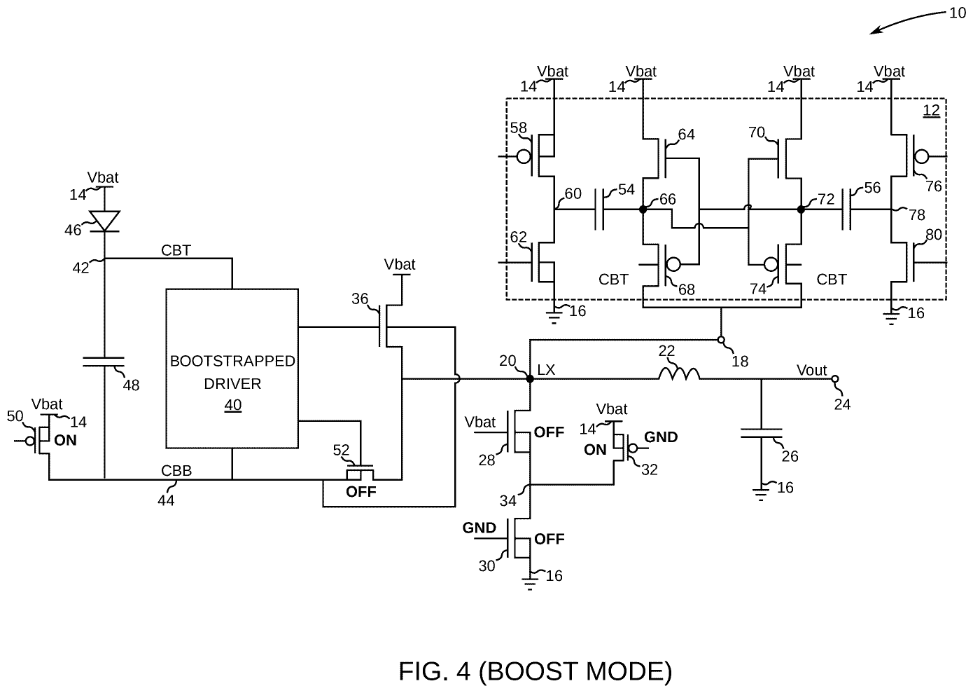

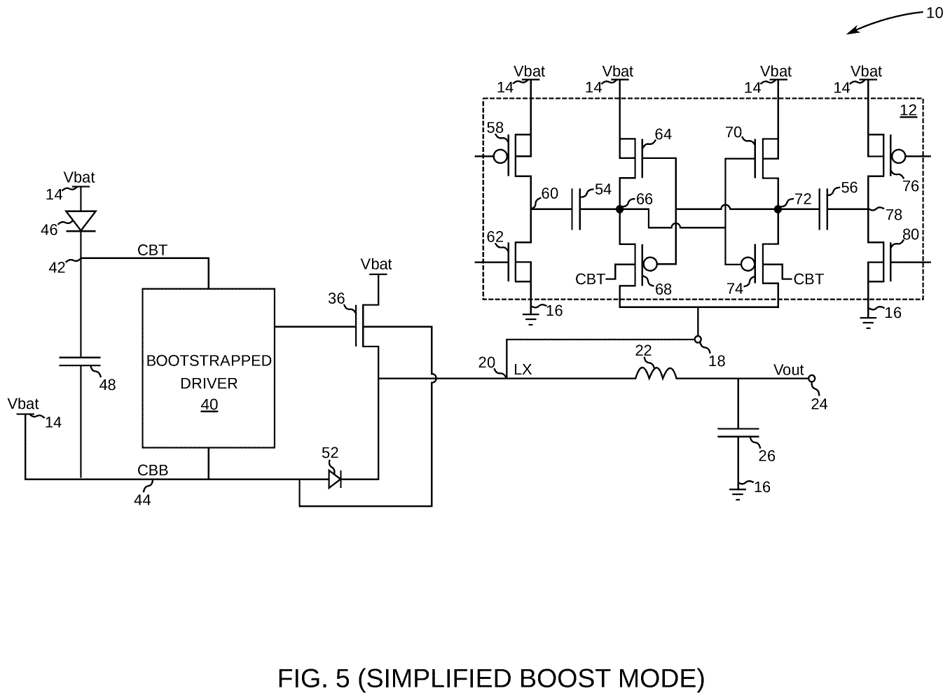

FIG. 4 is the schematic of the power converter stage 10 with static conduction states of transistors that are either on or off during a boost mode. The conduction states are labeled in bold text placed next to the symbols of the transistors that are either on or off during the boost mode. FIG. 5 is a simplified version of the schematic of FIG. 2 when the power converter stage 10 is operated in the boost mode. In the boost mode, the third ground-side transistor 32 is continuously on, which turns off the first ground-side transistor 28. The second ground-side transistor 30 is also turned off in the boost mode. The first bootstrap transistor 50 is depicted as a short because the first bootstrap transistor 50 is continuously on during boost mode operation. The second bootstrap transistor 52 is on but functions as a diode with an anode coupled to the second bootstrap node 44 and a cathode coupled to the switched node 20.

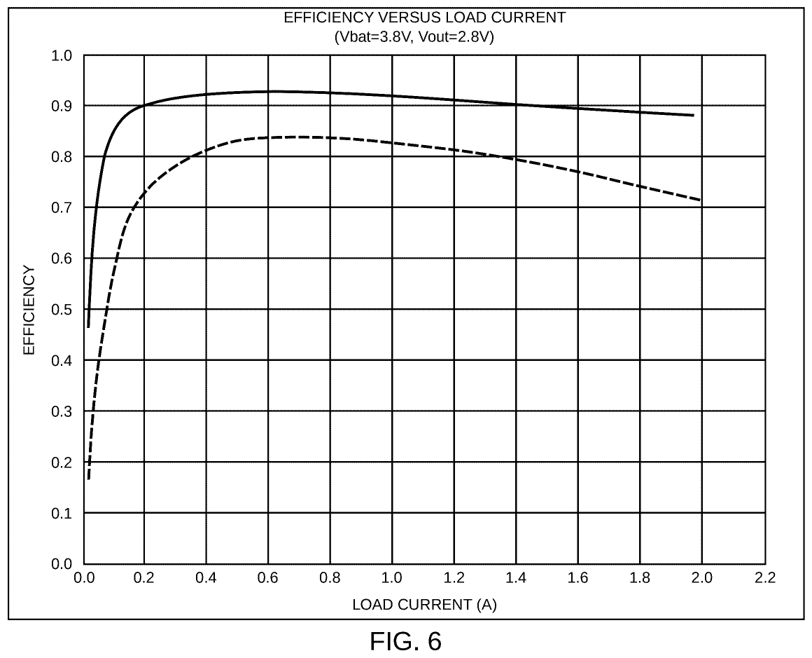

FIG. 6 is a graph of efficiency of the power converter stage 10 versus load current in comparison with traditional power converter circuitry of similar input voltage of 3.8 V and output voltage of 2.8 V. The efficiency performance of the traditional power converter circuitry is depicted in dashed line. The efficiency performance of the disclosed power converter stage 10 is depicted in solid line. The power converter stage 10 has an efficiency at least 90% between a load current of 0.2 Amperes (A) and 1.4 A. The efficiency of the traditional converter circuitry never reaches 90% and only rises above 80% between a load current of 0.4 A and 1.4 A. Notably, the efficiency of the present power converter stage 10 is substantially more efficient for all load currents between 0.1 A and 2.0 A. In comparison with traditional power converter circuitry the efficiency graph of FIG. 6 proves that the architecture of the exemplary embodiment of FIG. 1 may be used to make next generation integrated circuit dies that either are the same size with higher efficiency or integrated circuit die with the same efficiency but smaller in size.

From the efficiency graph presented in FIG. 6, it is noted that the main pump buck power stage in a traditional power converter circuit exhibits lower efficiency at low output currents. For this reason, an additional mini buck is integrated onto the die of the conventional power converter circuit. This auxiliary mini buck is utilized for low-power scenarios where the output voltage (Vout) is less than the battery voltage (Vbat). However, it is worth mentioning that this mini buck consumes a significant amount of area on the die.

The efficiency of the power converter stage 10, however, is sufficiently high enough that this additional mini buck is not necessary. To further improve low-power efficiency, NMOS transistors could be partitioned and used in buck mode. These enhancements are not necessary in any embodiments, but they will not substantially increase the die area if they are added.

Technically speaking, when comparing the efficiency between the traditional power converter circuitry and the power converter stage 10, it is possible to fabricate the power converter stage 10 with a larger power stage area than that of the traditional power converter circuit, enlarged by the size of the mini buck. This would make the efficiency difference between the power converter stage 10 and the traditional circuit even more pronounced.

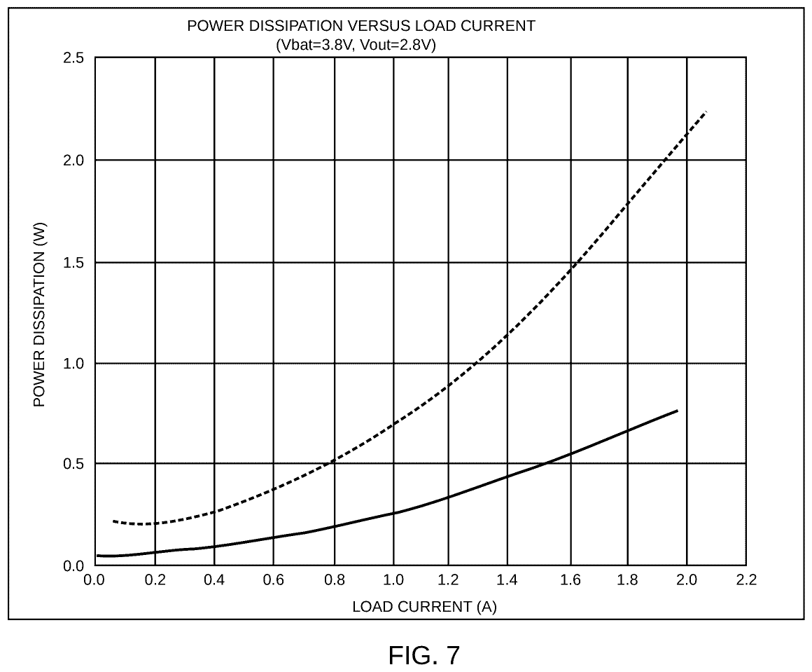

FIG. 7 is a graph of power dissipation of the power converter stage 10 versus load current in comparison with traditional power converter circuitry of similar voltage input of 3.8 V and voltage output of 2.8 V. The power dissipation performance of the traditional power converter circuitry is depicted in dashed line. The power dissipation performance of the disclosed power converter stage 10 is depicted in solid line. The power dissipation of the disclosed power stage 10 allows for substantially higher load currents for the same power dissipation, which is a highly desirable advantage over the traditional power converter circuitry.

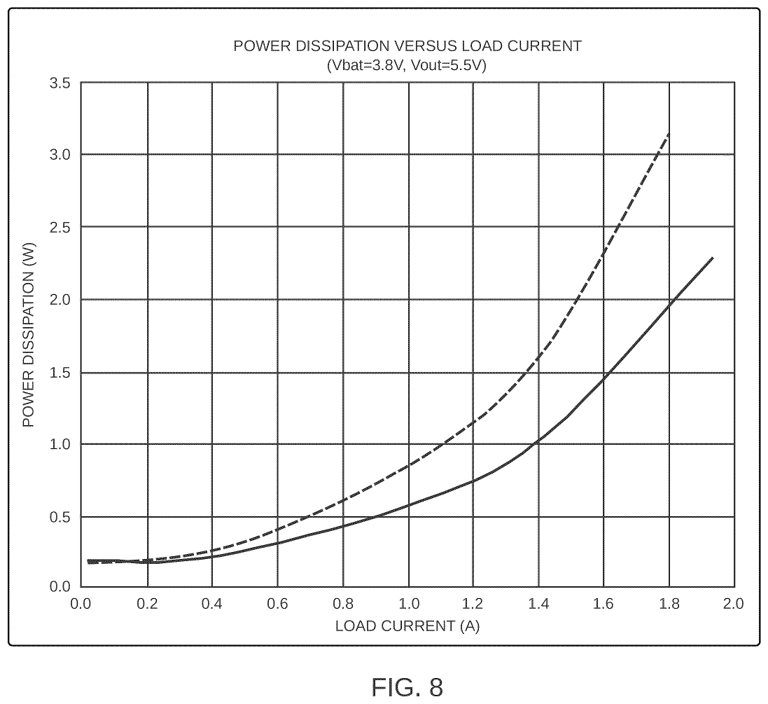

FIG. 8 is a graph of power dissipation of the power converter stage 10 versus load current in comparison with traditional power converter circuitry of similar voltage input of 3.8 V and voltage output of 5.5 V. The power dissipation performance of the traditional power converter circuitry is depicted in dashed line. The power dissipation performance of the disclosed power converter stage 10 is depicted in solid line. Even at the higher output voltage Vout=5.5 V, the power dissipation of the disclosed power stage 10 still allows for substantially higher load currents for the same power dissipation, which maintains the highly desirable advantage over the traditional power converter circuitry.

Moreover, the Vbat absolute maximum ratings (AMR) is an important parameter. A test device with the architecture of FIG. 1 was made to switch in buck mode with Vbat=6.5 V. A Vbat overprotection comparator was disabled, but the part was functional up to Vbat=6.7 V. The Vbat overvoltage comparator may be set within a range of 5.5 V to 6.0 V and the part is expected to survive Vbat voltages higher than 6.7 V.

For Vout greater than Vbat, LX is bucked between two times Vbat and Vbat in the boost mode. For a given Vout in boost mode, the duty cycle is less than that of traditional circuitry, which bucks between two times Vbat and ground. Having a lower duty cycle allows the low Ron NMOS of the high-side transistor 36 to be on for a larger fraction of the duty cycle, which increases the efficiency of the power converter stage 10.

For Vout less than Vbat, the high-side transistor 36 is used as a high-side switch and LX is bucked between Vbat and ground in the buck mode. The Ron of the high-side transistor 36 being an NMOS switch is much lower than that of the stacked PMOS high-side switch in traditional power converter circuitry, which results in higher efficiency for the power converter stage 10.

For Vout greater than Vbat, LX is bucked between two times Vbat and Vbat in the boost mode, the high-side transistor 36 (i.e., NMOS switch) serves the function of a low-side switch. For a given Vout in boost mode, the duty cycle is less than that of the traditional power converter circuitry, which bucks between two times Vbat and ground. Having a lower duty cycle allows the low Ron NMOS to be on for a larger fraction of the duty cycle for the power converter stage 10 than for traditional power converter circuitry, which increases the efficiency for the power converter stage 10.

Advantages of the disclosed power converter stage 10 have at least the following advantages over traditional power converter circuitry.
1. The disclosed power converter stage is an improvement over the traditional circuitry in terms of efficiency and power consumption.
2. The disclosed power converter stage has a lower resistance, which means it can save power when the output voltage is close to the battery voltage Vbat.
3. The disclosed power converter has a higher duty cycle for switching between the battery voltage Vbat and the zero voltage of ground. The higher duty cycle in buck mode means the high-side transistor 36 is on for a longer time, which increases overall efficiency.

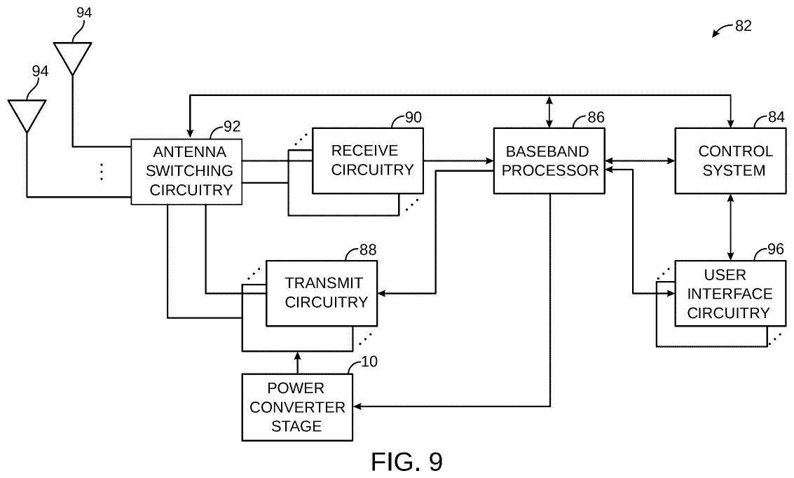

FIG. 9 is a diagram showing how the disclosed power converter stage 10 may be employed in communication devices such as wireless communication devices. With reference to FIG. 9, the concepts described above may be implemented in various types of wireless communication devices or user elements 82, such as mobile terminals, smart watches, tablets, computers, navigation devices, access points, and the like that support wireless communications, such as cellular, wireless local area network (WLAN), Bluetooth, near-field communications, and ultra-wideband ranging. The user elements 82 will generally include a control system 84, a baseband processor 86, transmit circuitry 88, receive circuitry 90, antenna switching circuitry 92, multiple antennas 94, and user interface circuitry 96. Amplifiers in the transmit circuitry 88 are powered from the power converter stage 10. The baseband processor 86 is configured to set appropriate output voltage for the transmit circuitry 88. The receive circuitry 90 receives radio frequency signals including ultra-wide bandwidth signals via the antennas 94 and through the antenna switching circuitry 92 from one or more basestations and/or other wireless communication devices configured like wireless communication device 82. A low-noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams.

The baseband processor 86 processes the digitized received signal to extract the information or data bits conveyed in the received signal. This processing typically comprises demodulation, decoding, and error correction operations. The baseband processor 86 is generally implemented in one or more digital signal processors and application-specific integrated circuits.

For transmission, the baseband processor 86 receives digitized data, which may represent voice, data, or control information, from the control system 84, which it encodes for transmission. The encoded data is output to the transmit circuitry 88, where it is used by a modulator to modulate a carrier signal that is at a desired transmit frequency or frequencies, such as ultra-wideband frequencies, which span 3.1 GHz to 10.5 GHZ. The bandwidth of ultra-wideband is greater than 500 MHZ.

A power amplifier will amplify the modulated carrier signal to a level appropriate for transmission and deliver the modulated carrier signal through the antenna switching circuitry 92 to the antennas 94. The antennas 94 and the replicated transmit circuitry 88 and receive circuitry 90 may provide spatial diversity. Modulation and processing details will be understood by those skilled in the art.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. A power converter stage comprising:
a high-side transistor coupled between a supply voltage node configured to receive a supply voltage (Vbat) and a switched node (LX), wherein the high-side transistor is an n-type metal oxide semiconductor (NMOS) transistor;
a charge pump circuit coupled between the supply voltage node and the switched node LX, configured to generate a higher output voltage (Vout) when operating in a boost mode;
a bootstrapped driver configured to selectively activate the high-side transistor based on a desired output voltage level, wherein:
when the desired output voltage is lower than the supply voltage (Vout<Vbat) in a buck mode, the high-side transistor operates as a high-side switch to buck the switched node LX between the supply voltage Vbat and ground;
when the desired output voltage is higher than the input voltage (Vout>Vbat) in the boost mode, the high-side transistor operates as a low-side switch to switch the switched node LX between Vbat and two times Vbat via the charge pump circuit.

2. The power converter stage of claim 1 wherein the bootstrapped driver is further configured to activate the high-side transistor to function as a high-side switch in buck mode when the output voltage Vout is close to the supply voltage Vbat, thereby maximizing the duty cycle of the high-side transistor by the use of the low-side switch function to improve efficiency.

3. The power converter stage of claim 2 wherein the high-side transistor is configured to provide the power converter stage with an energy efficiency of at least 90% for load currents that range between 0.2 amperes (A) and 1.4 A.

4. The power converter stage of claim 1 further comprising an inductor coupled between the switched node and a voltage output terminal.

5. The power converter stage of claim 4 wherein the inductor has an inductance of between 0.1 μH and 2 μH.

6. The power converter stage of claim 1 wherein the bootstrap driver is coupled between a first bootstrap node and a second bootstrap node.

7. The power converter stage of claim 6 further comprising:
a diode having an anode coupled between the supply voltage node and the first bootstrap node;
a bootstrap capacitor coupled between the first bootstrap node and the second bootstrap node;
a first bootstrap transistor coupled between the voltage supply node and the second bootstrap node; and
a second bootstrap transistor coupled between a source of the high-side transistor and the second bootstrap node.

8. The power converter stage of claim 7 wherein the bootstrapped driver is configured to turn off the first bootstrap transistor and turn on the second bootstrap transistor when operating in the buck mode.

9. The power converter stage of claim 7 wherein the bootstrapped driver is configured to turn on the first bootstrap transistor and turn off the second bootstrap transistor when operating in the boost mode.

10. A method of operating a power converter stage comprising:
generating a higher output voltage (Vout) using a charge pump circuit coupled between a supply voltage node having a supply voltage (Vbat) and a switched node (LX), when operating in a boost mode;
selectively activating a high-side transistor, which is an n-type metal oxide semiconductor (NMOS) transistor coupled between the supply voltage node and the switched node LX based on a desired output voltage level:
when the desired output voltage is lower than the supply voltage (Vout<Vbat) in a buck mode, the high-side transistor is activated as a high-side switch to buck the switched node LX between the supply voltage Vbat and ground;
when the desired output voltage is higher than the input voltage (Vout>Vbat) in the boost mode, the high-side transistor is activated to function as a low-side switch to switch the switched node LX between Vbat and two times Vbat via the charge pump circuit.

11. The method of operating the power converter stage of claim 10 comprising:
activating a high-side transistor to function as a low-side switch in buck mode when the output voltage Vout is close to the supply voltage Vbat; and
maximizing the duty cycle of the high-side transistor by the use of the low-side switch function, thereby improving efficiency.

12. The method of operating the power converter stage of claim 11 wherein the energy efficiency of the power converter stage is at least 90% for load currents that range between 0.2 amperes (A) and 1.4 A.

13. A wireless communication device comprising:
receive circuitry configured to receive radio frequency (RF) signals;
a baseband processor configured to process a digitized version of the RF signals received by the receive circuitry and to extract the information or data bits conveyed in the received RF signals;
transmit circuitry configured to receive encoded data from the baseband processor and to modulate a carrier signal with the encoded data; and
a power converter stage comprising:
a high-side transistor coupled between a supply voltage node having a supply voltage (Vbat) and a switched node (LX), wherein the high-side transistor is an n-type metal oxide semiconductor (NMOS) transistor;
a charge pump circuit coupled between the supply voltage node and the switched node LX, wherein the charge pump is configured to generate a higher output voltage (Vout) when operating in a boost mode; and
a bootstrapped driver configured to selectively activate the high-side transistor based on a desired output voltage level, wherein:
when the desired output voltage is lower than the supply voltage (Vout<Vbat) in a buck mode, the high-side transistor operates as a high-side switch to buck the switched node LX between the supply voltage Vbat and ground; and
when the desired output voltage is higher than the input voltage (Vout>Vbat) in the boost mode, the high-side transistor is activated to function as a low-side switch to switch the switched node LX between Vbat and two times Vbat via the charge pump circuit.

14. The wireless communication device of claim 13 wherein the bootstrapped driver is further configured to activate the high-side transistor to function as a low-side switch in buck mode when the output voltage Vout is close to the supply voltage Vbat, thereby maximizing the duty cycle of the high-side transistor by the use of the low-side switch function to improve efficiency.

15. The wireless communication device of claim 14 wherein the high-side transistor is configured to provide the power converter with an energy efficiency of at least 90% for load currents that range between 0.2 amperes (A) and 1.4 A.

16. The wireless communication device of claim 13 further comprising an inductor coupled between the switched node LX and a voltage output terminal.

17. The wireless communication device of claim 16 wherein the inductor has an inductance of between 0.1 μH and 2 μH.

18. The wireless communication device of claim 13 wherein the baseband processor is configured to transmit desired output voltage levels to the bootstrapped driver.

19. The wireless communication device of claim 13 wherein the bootstrap driver is coupled between a first bootstrap node and a second bootstrap node.

20. The wireless communication device of claim 19 further comprising:
a diode having an anode coupled between the supply voltage node and the first bootstrap node;
a bootstrap capacitor coupled between the first bootstrap node and the second bootstrap node;
a first bootstrap transistor coupled between the voltage supply node and the second bootstrap node; and
a second bootstrap transistor coupled between a source of the high-side transistor and the second bootstrap node.
